(19) United States
(12) Patent Application Publication
(10) Pub. No.: US 2019/0089810 A1
(43) Pub. Date: Mar. 21, 2019

(54) RESOURCE ACCESS METHOD, APPARATUS, AND SYSTEM

(71) Applicant: Alibaba Group Holding Limited, George Town (KY)

(72) Inventors: Fengyuan Wu, Hangzhou (CN); Ning Li, Hangzhou (CN); Xianghong Jia, Hangzhou (CN)

(21) Appl. No.: 16/041,356

(22) Filed: Jul. 20, 2018

Related U.S. Application Data
(63) Continuation-in-part of application No. PCT/CN2017/071556, filed on Jan. 18, 2017.

(30) Foreign Application Priority Data
Jan. 28, 2016 (CN) 201610059809.0

(51) Int. Cl. H04L 29/08; G06F 9/50; G06F 16/955; H04L 29/06; G06F 21/62

(52) U.S. Cl. CPC H04L 67/327; G06F 9/5005; G06F 16/955; G06F 2221/2141; H04L 63/101; G06F 21/62; H04L 63/102

(57) ABSTRACT

Embodiments of the present application disclose a method, means, and system for accessing resources. The method includes obtaining, by one or more processors, a resource access request, the resource access request comprising an identifier for a resource for which access is requested, obtaining, by the one or more processors, at least a resource type of the resource and a relative path corresponding to the resource, the resource type and the relative path being obtained based at least in part on the identifier included in the resource access request, determining, by the one or more processors, an absolute path corresponding to the resource, the absolute path being determined based at least in part on one or more of the resource type and the relative path, and accessing, by the one or more processors, the resource based at least in part on the absolute path corresponding to the resource.

### CROSS REFERENCE TO OTHER APPLICATIONS

This application is a continuation-in-part of and claims priority to International (PCT) Application No. PCT/CN2017/71556 entitled RESOURCE ACCESS METHOD, APPARATUS AND SYSTEM, filed Jan. 18, 2017 which is incorporated herein by reference for all purposes, which claims priority to China Application No. 201610059809.0 entitled A METHOD, MEANS, AND SYSTEM FOR ACCESSING RESOURCES, filed Jan. 28, 2016 which is incorporated herein by reference for all purposes.

### FIELD OF THE INVENTION

The present application relates to a field of communication technology. In particular, the present application relates to a method, apparatus, and system for accessing resources.

### BACKGROUND OF THE INVENTION

As communication technology develops, applications for use on a mobile terminal, and in particular, applications for use on a mobile terminal that communicates with one or more servers via the Internet are becoming more numerous in order to satisfy diverse and continually growing business needs.

According to current art, Internet application-based resource access generally requires that an absolute path of a target resource be carried in a resource access request in order for the resource to be accessed. The resource storage structure of an Internet application (e.g., an application that generally provides a service based on information obtained from one or more servers) is generally rather complex. For example, the resource storage structure of an Internet application has quite a few directory levels, and the absolute path (the full path that points to a specific location regardless of the current working directory or location) of a resource is generally quite long. Because the absolute path is generally long for a resource used in connection with an Internet application, the absolute path can be inefficient or prone to errors in the context of accessing a particular resource. For example, path errors may easily cause resource access failures. In addition, when the resource storage structure changes, resource access may be easily hindered by errors in the absolute path. If resource access is to occur via an absolute path, then a change to a resource storage structure needs to be propagated to the absolute path used to access a particular resource (e.g., the absolute path is to be correspondingly changed). As an example, an absolute path is a path that points to (e.g., is associated with) a location at which a resource is located. An absolute path contains the root directory and all other subdirectories in which a file or folder is contained. The absolute path is in contrast to a relative path, which can point to the same location as the absolute path, however, the relative path starts from a certain working directory or working location.

In view of the above, there is a need for a resource scheme that overcomes the deficiencies described above.

### BRIEF DESCRIPTION OF THE DRAWINGS

Various embodiments of the invention are disclosed in the following detailed description and the accompanying drawings.

FIG. 1 is a structural diagram of a resource access system according to various embodiments of the present application.

FIG. 2 is a flow chart of a method for resource access according to various embodiments of the present application.

FIG. 3 is a structural diagram of a terminal according to various embodiments of the present application.

FIG. 4 is a functional diagram of a computer system for resource access according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a terminal generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

In some embodiments, a “smart terminal” is a terminal device having multimedia functions. A smart terminal supports audio, video, data, and other such functions. The smart terminal can have a touchscreen. The smart terminal can correspond to a smart mobile device such as a smart phone, a tablet computer, or a smart wearable device, or a smart television, personal computer, or other such device with a touchscreen. Various operating systems such as Android, iOS, YunOS, and tvOS can be implemented on the smart terminal. Various embodiments discussed herein are in the context of the example of a television device using tvOS; however, other types of terminals or operating systems can be used. A smart terminal can be connected to one or more networks such as the Internet, a WiFi network, a Local Area Network (LAN), a Wide Area Network (WAN), a telecommunications network, etc.

A smart terminal can be connected to one or more peripherals (e.g., smart peripherals). For example, the smart terminal can be connected to one or more peripherals via a Bluetooth connection, a WiFi direct connection, an infrared connection, a ZigBee connection, a Bluetooth Low Energy (BLE) connection, a WiMax connection, a Low Power Radio (LPR) connection, a Near Field Communications (NFC) connection, etc.

Concise explanations of various technical terms used herein in connection with describing various embodiments are provided below.

(1) Resource

In an operating system, such as a YunOS system, the term “resource” refers to the data and resources of an application. The data of an application comprises static data and runtime data, and the resources of an application can be a local service (e.g., a local system service or self-defined service) or a remote service (e.g., a cloud service).

With regard to applications, resources can include resources of an application and application runtime resources. Resources of an application can refer to the code for the application, such as decompressed application data. Resources of an application can also be referred to herein as an application resource. Application runtime resources can refer to resources generated while an application is running. An example of application runtime resources can be a data processing result. Application runtime resources can also be referred to herein as runtime resources.

In some cloud operating systems, such as YunOS, a resource can be manifested as a Page.

As used herein, a “Page” refers to a set of code implementing a service component. For example, a “Page” is an abstraction of local service and remote service (e.g., a basic unit of service). A page can provide various kinds of services by packaging data and according to various methods. The data can be packaged in a file folder, a zip file, etc. Providing services via a page can correspond to the manner by which services are provided via a webpage. A service can include multiple Pages. For example, a Page can be a user interface (UI) or a service such as picture-taking. As another example, a Page can be a background service, such as account authentication. A Page that is running is called a Page instance. A Page (e.g., a Page instance) can be a running carrier for a local service or a remote service. A Page instance can be created, scheduled, or managed by Dynamic Page Manager Service (DPMS). DPMS can maintain the life cycle of a Page instance.

Each Page can be uniquely identified within YunOS. For example, a Uniform Resource Identifier (URI) can be used to identify a Page. As an example, a URI can be an address link. The use of a URI to identify a Page (e.g., having a URI associated with a Page) ensures that a corresponding Page can be uniquely determined. For example, to differentiate a service provided by a Page, the URI corresponding to (e.g., assigned to) the Page can selectively include relevant information of the service, such as service title, service content, service provider, etc.

Events and/or data can be transmitted between Pages. A Page can interact with a user via a UI to provide service, and/or conversely, a user can interact with a Page via a UI to obtain a corresponding service.

(2) Domain

As used herein, “domain” can be understood as a logical component of an application. Domain partitioning helps to isolate authorizations and other management configuration operations. Domain partitioning can include obtaining a subset of a domain. For example, for a domain page://yongsheng/tv.yunos.com/data/document/test/test.html?name=“good”&value=“1”, the domain partitioning can obtain tv.yunos.com.

Various embodiments define a resource identifier format in connection with providing uniform resource identifiers for facilitating resource access. The defined resource identifier format includes a path field. The path field can be used for carrying the relative path of a resource (e.g., a resource corresponding to a resource access request). The relative path can refer to the path of the resource within the domain of the application.

According to various embodiments, the defined resource identifier comprises one or more resource type fields. The defined resource identifier can comprise a resource type field and a resource identifier format. The one or more resource type fields can be used for carrying information that indicates resource type. As used herein, a “resource type” is defined in terms of resource storage. To give an example, resources stored in external memory of a terminal are classed as one type of resource. An example of external memory within a terminal includes memory other than a subscriber identification card such as a SIM (Subscriber Identity Module) card. For example, a resource on an SD card (Secure Digital Memory Card) is a type of resource. The resource stored on an SD card can be differentiated from a resource stored on a mobile terminal SIM card or similar subscriber identification card or a resource stored on a network (e.g., the cloud).

In some embodiments, an SD card of a terminal stores runtime resources of an application. For example, the SD card of a terminal can be used to only store runtime resources of the application. The SIM card of the terminal can store resources of the application and runtime resources. According to various embodiments, resources of an application and runtime resources for the application are stored in different directories. The resource type can indicate whether a corresponding resource is a resource of an application or a runtime resource for the application. For example, the resource type can include an identifier that indicates whether a corresponding resource is a resource of an application or a runtime resource for the application. The resource type can be extended to include the indication of whether the corresponding resource is a resource of an application or a runtime resource for the application based on the data structure according to which resources of an application and runtime resources for the application are stored in different directories. According to various embodiments, resources can correspond to various resource types. Three resource types are discussed below—called a first type, a second type, and a third type.

First type: the first type of resource can be used in connection with indicating that the corresponding resource is stored in external memory (e.g., an SD card inserted into the terminal, etc.).

Second type: the second type of resource can be used in connection with indicating that the corresponding resource is not stored in external memory. For example, if a resource is deemed to be a second type of resource, the resource is stored locally. As an example, a resource of a second type is not stored external memory, but in a SIM card of the terminal (e.g., in contrast to an SD card that is external memory). In some embodiments, the second type of resource can be used in connection with indicating that the corresponding resource is a resource of the application, such as a resource following decompression of an application installation package. According to various embodiments, a second type of resource is a resource that is not stored in external memory and is a resource of the application (e.g., decompressed application data, etc.).

Third type: the third type of resource can be used in connection with indicating that the resource is not stored in external memory. For example, if a resource is deemed to be a third type of resource, the resource is stored locally. As an example, a resource of a third type is not stored external memory, but in a SIM card of the terminal, etc. In some embodiments, the third type of resource can be used in connection with indicating that the corresponding resource is a runtime resource of the application. For example, a resource that corresponds to the third type of resource can be a resource that is generated while the corresponding application is running. According to various embodiments, a third type of resource is a resource that is not stored in external memory and is a runtime resource of the application.

In some embodiments, a resource can be a fourth type of resource.

Fourth type: the fourth type of resource can be used in connection with indicating that the corresponding resource is stored on a network (such as the cloud). In some embodiments, a resource is deemed to be a fourth type of resource if the resource is stored remotely in relation to the terminal.

Various embodiments define the resource type field in a resource identifier in terms of the first resource type, the second resource type, and the third resource type, discussed above. The resource type fields can be used in connection with differentiating among the various resource types. For example, different values can be used to indicate a corresponding resource type. For a resource of a first resource type, the resource type field corresponding to such resource can have a particular value or string (e.g., that indicates that the resource is a first resource). For a resource of a second resource type, the resource type field corresponding to such resource can have a particular value or string (e.g., that indicates that the resource is a second resource). For a resource of a third resource type, the resource type field corresponding to such resource can have a particular value or string (e.g., that indicates that the resource is a third resource). The resource type field could be one field or multiple fields (e.g., the resource type field can have one or more fields).

In some embodiments, a resource identifier format comprises at least two resource identifier fields: a first field (e.g., the “scheme” field) and a second field (e.g., the “subscheme” field). As an example, if the resource type in this resource identifier format is the first type, then the value of the “scheme” field corresponds to “file.” In this case, a “subscheme” field is not needed, or the “subscheme” field takes a null value. As another example, if the resource type in this resource identifier format is a second type or a third type, then the “scheme” field's value corresponds to “page.” In this case, the “subscheme” field can be used for further differentiation. For example, if the resource type is a second type, then the value of the “subscheme” field corresponds to “asset,” and if the resource type is a third type, then the value of the “subscheme” field corresponds to “data.” In some embodiments, the first field (e.g., the “scheme” field) further includes a value of “http” or “https,” indicating that the corresponding resource that is being accessed is a resource stored on the Internet, such as a cloud resource.

In some embodiments, the resource storage structure is set using the domain to which the resource belongs. An example of a resource storage structure is such that resources that belong to the same domain are saved under the same directory, and resources that belong to different domains are saved under different directories. A determination of whether resources belongs to a same domain or different can be made based on the respective domain names corresponding to the resources (e.g., the domain names in the absolute paths of the resources). For such a resource storage structure, the corresponding defined resource identifier format can comprise an information field in connection with indicating the domain to which the resource belongs. The information field that indicates the domain to which the resource belongs can comprise indicating information (e.g., a domain name) of the domain to which the resource belongs.

In some embodiments, resources associated with the use of an application by various users are stored in different directories (e.g., different user directories). For example, when different users use the same application, the associated resources (e.g., with the various users' use of the application) are saved under different user directories. As an example, different user directories can be created using an identifier for the corresponding users. For example, the different directories can be created based on (e.g., using) the user names of the users that use the application. Such a naming or identifying convention can enable resources associated with different users to be saved in different directories. According to various embodiments, for such a resource storage structure, the (defined) resource identifier format comprises a user information field. The user information field can be used in connection with carrying user information (e.g., a username, an identifier associated with a user, etc.) that indicates the user that is using the application. For example, when using an application, a user first logs in to the application (or the terminal). In some embodiments, the user can issue a resource access request after the user logs into the application (or the terminal). In some embodiments, the user can only issue a resource access request if the user has first logged in to the application, the terminal, and/or a service (e.g., a web service) associated with the application. The user information comprised in the identifier for the target resource associated with (e.g., requested by) the issued resource access request corresponds to the user information for the user that is logged in. For example, the user information can comprise (or be based at least in part on) the user name used in connection with the user's login.

In some embodiments, the (defined) resource identifier format further comprises a parameter field. The parameter field can be used in connection with carrying a parameter that is to be transmitted when a resource is being accessed. As an example, transmission of the parameter can comprise a prompt provided on the terminal, or providing the parameter to another application on the terminal, or providing the parameter to another page in the same app. For example, the parameter field can comprise information associated with a parameter that is to be transmitted in response to the resource being accessed. For example, in the case of an Internet payment application, the bank card number used for payment can serve as a parameter comprised in the parameter field in a resource identifier. The parameter comprised in the parameter field can be communicated to a web server associated with the application. In the context of the example of the Internet payment application, the bank card number used for payment can be communicated (via one or more networks) to a server associated with a bank (e.g., a payment server, a transaction server, etc.) or the like.

According to various embodiments, the position in the resource identifier for information fields (e.g., the information fields discussed above) is defined in advance. For example, a structure of the resource identifier can be defined in advance (e.g., according to a template or protocol).

In some embodiments, Uniform Resource Identifiers (URIs) are used to identify resources. For example, the URIs can be used to identify resources based at least in part on the resource identifier format definition, such as the resource identifier format definition discussed above. The URI format can comply with H5 protocol specifications and can be compatible with W3C's HyperText Transfer Protocol (HTTP), Hyper Text Transfer Protocol over Secure Socket Layer (HTTPS), and other such protocols. An example format of a resource URI is presented below:

scheme://username/domain/subscheme/path?param1=xxx&param2=xxx

The information fields provided in the above URI format are discussed below:

Scheme field: the scheme field can correspond to a resource type field. The scheme field can correspond to a resource type field used in connection with carrying resource type indicating information. In some embodiments, the scheme field is a mandatory field in the resource identifier format. In some embodiments, the value (or string) of the scheme field comprises “page” or “file.” For example, if the value of the “scheme” field corresponds to the value “file,” the resource can be determined to be a first type of resource. As another example, if the “scheme” field corresponds to the value “page,” then the terminal determines that the resource type is to be further determined according to the value of the “subscheme” field. The “scheme” field can also have a value corresponding to “http” or “https,” indicating that the resource to be accessed is a cloud resource.

Subscheme field: the subscheme field can correspond to an extension resource type field. The subscheme field can correspond to an extension resource type field used in connection with carrying resource type extended indicating information. In some embodiments, the resource type extended indicating information and/or the subscheme field is optional. As an example, if the “scheme” field corresponds to the value “file,” the resource identifier (e.g., the URI) and/or the resource identifier format does not include a “subscheme” field. As another example, if the “scheme” field corresponds to the value “file,” the resource identifier (e.g., the URI) and/or the resource identifier format comprises a “subscheme” field corresponding to a null value. In some embodiments, if the “scheme” field corresponds to the value “page,” the resource identifier (e.g., the URI) and/or the resource identifier format includes a “subscheme” field. The value of the “subscheme” field can correspond to “asset” or “data.” For example, the value of the “subscheme field” can correspond to “asset” or “data” if the “scheme” field corresponds to the value “page.” In some embodiments, if the “sub scheme” field corresponds to the value “asset,” the corresponding resource is deemed to be a resource of the application (e.g., decompressed application data). In some embodiments, if the “subscheme” field corresponds to the value “data,” the corresponding resource is deemed to be a runtime resource of the application.

Username field: The username field can correspond to a field used in connection with carrying information associated with the user corresponding to the resource access request. For example, the username field can comprise information that identifies the user corresponding to the resource access request (e.g., the user that issued the resource access request). The username field can comprise a username of a user, an identifier associated with the user, etc.

Domain field: The domain field can correspond to a field used in connection with carrying information associated with a domain. For example, the domain field comprises information that indicates the domain to which the resource (e.g., the resource corresponding to the resource access request) belongs. The domain field can comprise a domain name, an identifier associated with the domain, etc.

Path field: the path field can be used in connection with carrying a path corresponding to the resource in the domain to which the resource belongs. In some embodiments, the path field comprises path information corresponding to the resource (e.g., the resource corresponding to the resource access request). The path information comprised in the path field can comprise, or otherwise correspond to, the relative path. The path information can provide a path of the resource in the domain to which the resource belongs. The path field can correspond to a value “asset” or “data.” “Asset” or “data” in this case represents the structure of the relative path (e.g., a single-level directory therein).

Param field: the param field can be used in connection with carrying parameters to be transmitted. For example, the param field can comprise information that needs to be communicated in connection with the resource access request. The param field can be represented using name-value pairs.

The following is an example of a URI used to identify a resource:

page://yongsheng/tv.yunos.com/data/document/test/test.html?name=“good”&value=“1”

Referring to the URI above, the URI indicates that: the resource type is a third type (e.g., the value of the “scheme” field is “page”; the value of the “subscheme” field is “data”). The domain to which the resource belongs is “tv.yunos.com”; the path of the resource in the domain to which it belongs is “document/test/test.html”; the transmitted parameter packet includes “name=‘good’&value=‘1’”; and the username of the user associated with the resource access request (e.g., the user that issued the resource access request) is “yongsheng.”

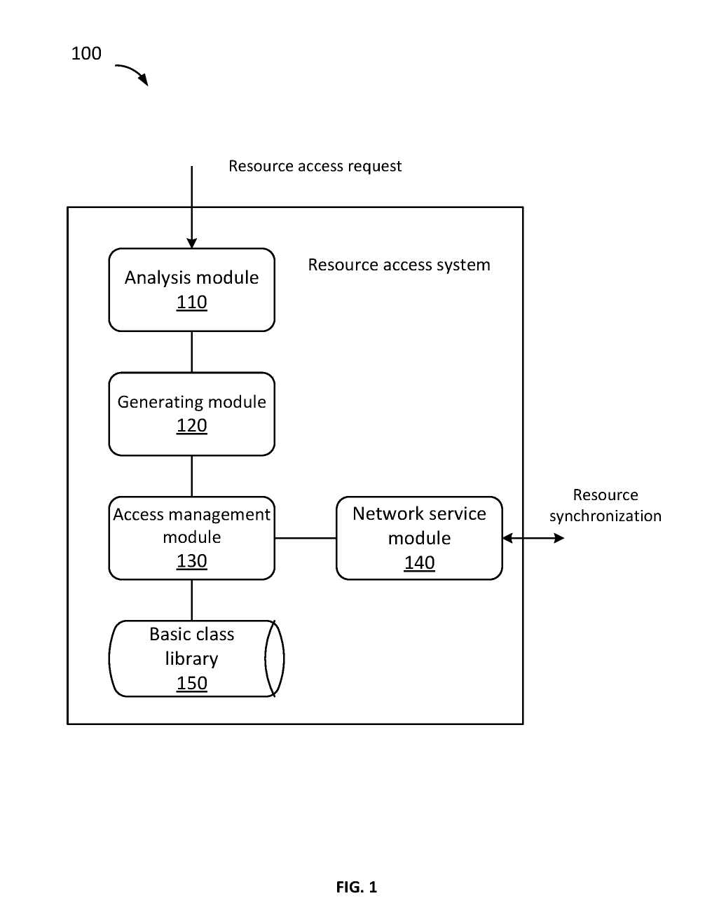

FIG. 1 is a structural diagram of a resource access system according to various embodiments of the present application.

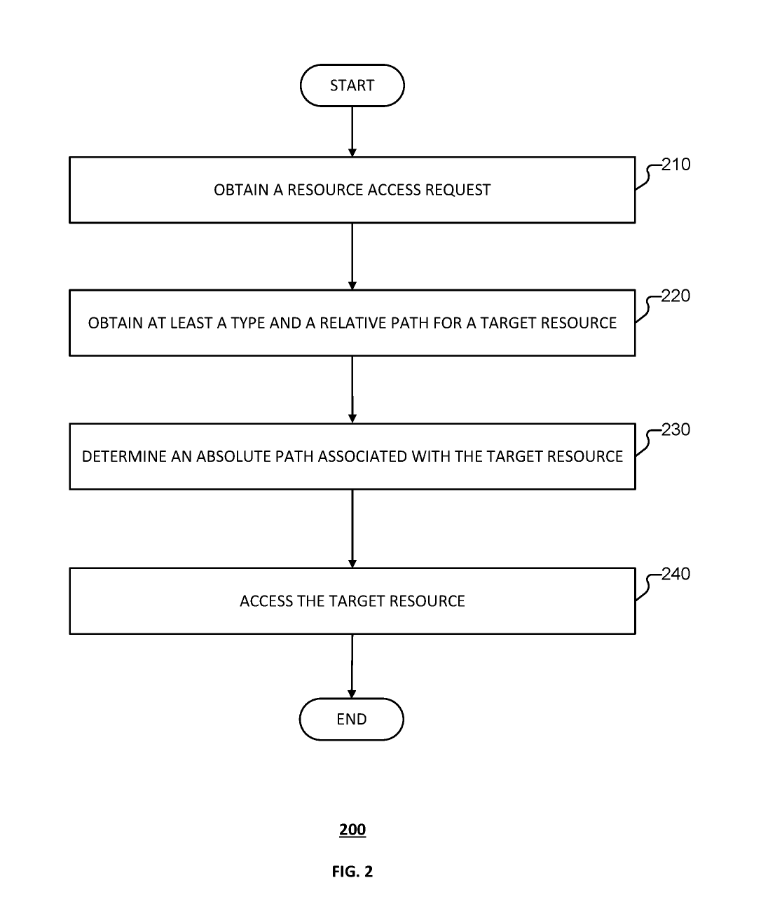

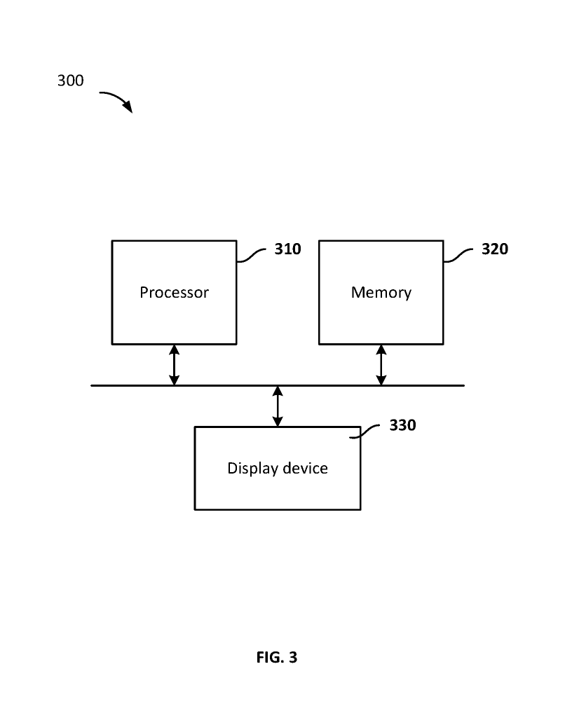

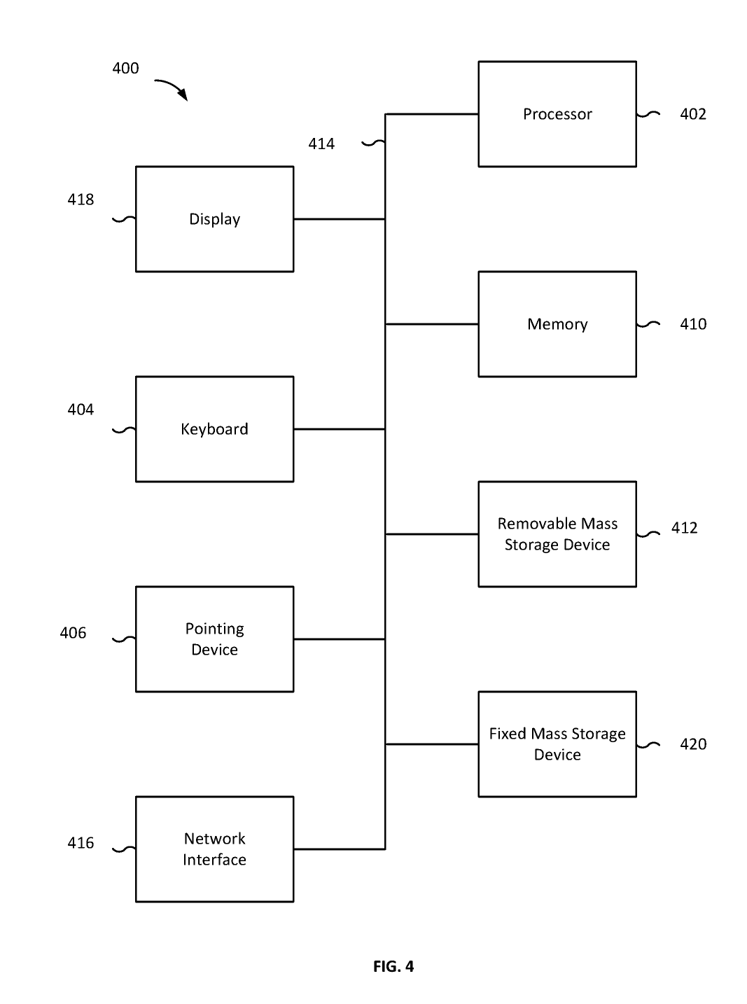

Referring to FIG. 1, resource access system 100 is provided. Resource access system 100 can implement process 200 of FIG. 2. Resource access system 100 can be implemented, at least in part, by terminal 300 of FIG. 3, and/or computer system 400 of FIG. 4.

In some embodiments, resource access system 100 is located on the terminal side. For example, a terminal can implement the resource access system 100. According to various embodiments, resource access system 100 is implemented by software, hardware, or a combination of software and hardware. As an example, resource access system 100 is implemented on the basis of C++, Node.js, JS, or other technology.

As illustrated in FIG. 1, resource access system 100 comprises: analysis module 110, generating module 120, access management module 130, network service module 140, and/or basic class library 150.

Analysis module 110 is configured to provide the ability to analyze resource identifiers. Analysis module 110 can analyze the resource identifier comprised in a resource access request. For example, in response to the terminal (or an application running on the terminal) obtaining a resource access request, the analysis module 110 can obtain a resource identifier from the resource access request and determine various information from the resource identifier, such as the relative path of the resource. The analysis module 110 can analyze a URI associated with, or corresponding to, a resource.

Generating module 120 can be configured to provide a function for generating a path corresponding to a resource (e.g., a resource determined by the analysis module 110). In some embodiments, the generating module 120 generates one or more absolute paths based on one or more relative paths. The generating module 120 can determine a path (e.g., the one or more absolute paths). For example, the generating module 120 can determine the path based at least in part on the resource, a resource access request, etc.

Access management module 130 is configured to provide resource access and management capabilities. The access management module 130 can provide resource access based at least in part on a resource access request that is received (e.g., by a terminal, by an application running on the terminal, etc.). As an example, access management module 130 provides resource access to a resource corresponding to a resource identifier that is determined by the analysis module 110 and/or a path determined (or generated) by generating module 120. The access management module 130 can be configured to provide one or more resource management capabilities. The one or more resource management capabilities can comprise managing resource directories (e.g., creating, modifying, deleting resource directories, etc.), copying resources to different directories, etc.

According to various embodiments, during a resource access process, the analysis module 110 obtains (e.g., receives) a resource access request, analyzes (e.g., determines) a target resource identifier comprised in the resource access request, and obtains at least a resource type corresponding to the target resource, and a relative path for the target resource. The generating module 120 determines (e.g., generates) an absolute path corresponding to the target resource based at least in part on information obtained through analysis. For example, the generating module 120 determines the absolute path for a target resource (e.g., the resource corresponding to the resource access request) based at least in part on the resource identifier corresponding to the target resource, the resource type corresponding to the target resource, and/or the relative path for the target resource, etc. The access management module 130 can be further configured to access the target resource based at least in part on the absolute path of the target resource. In some embodiments, in response to accessing and obtaining the resource (e.g., the target resource), the access management module 130 provides the obtained resource to a browser engine for rendering a new page layout and refreshing the display. For example, the terminal can display the resource and/or information associated with the resource in response to the terminal obtaining the resource (e.g., based at least in part on the resource access request).

In some embodiments, the access management module 130 performs resource access operations, including open, shut, read, and write operations, etc., based at least in part on a basic class library 150. The terminal can store the basic class library 150. The basic class library 150 can be stored locally at the terminal or remotely. The basic class library 150 can be implemented on the basis of Portable Operating System Interface (POSIX) files. The POSIX standard defines interface standards that the operating system provides to applications.

In some embodiments, resource access system 100 may further comprise a network service module 140. The network service module 140 can be configured to provide communications with one or more networks. In response to the access management module 130 failing to access a resource (e.g., in response to a failure to find the target resource), the terminal (e.g., the access management module 130) can launch (e.g., invoke) a resource synchronization process via the network service module 140. In some embodiments, in response to a failure to access a resource, the terminal can invoke a process for obtaining the resource associated with the resource access request from a remote storage (e.g., via one or more servers connected to one or more networks). The network service module 140 can interact with a remote server and carry out resource synchronization (or an obtaining of the resource) and/or update with a remote server via a protocol such as HTTP or HTTPS.

FIG. 2 is a flow chart of a method for resource access according to various embodiments of the present application.

Referring to FIG. 2, process 200 for resource access is provided. Process 200 can be implemented by system 100 of FIG. 1, terminal 300 of FIG. 3, and/or computer system 400 of FIG. 4.

At 210, a resource access request is obtained. In some embodiments, the terminal obtain the resource access request. For example, the terminal can receive the resource access request in response to a user input to the terminal (e.g., via a user interface such as a graphical user interface, a voice input, etc.). In response to the user input to the terminal, an application (or a process running on the operating system) can generate a resource access request. The resource access request can be obtained in connection with an input to the terminal, wherein the input is associated with a resource. For example, the input to the terminal can include a selection of a resource (e.g., a particular resource), a query that is input for querying a storage for one or more resources responsive to query parameters associated with the query, and/or the like. The resource access request can be generated based on an input from a user, generated by an application, an operating system (OS), a server, etc. As an example, in response to the resource access request being generated, the resource access request is provided to the target application and/or operating system.

According to various embodiments, the resource access request comprises an identifier corresponding to a resource (e.g., the target resource) for which access is requested. The identifier (e.g., a resource identifier) can indicate the particular resource for which resource is being requested. For example, the identifier can be a URI that identifies the resource. In some embodiments, a format of a resource identifier is defined in advance (e.g., according to a template, protocol, etc.). In some embodiments, a format of the resource access request is defined in advance (e.g., according to a template, protocol, etc.). As an example, in response to an event (e.g., a user input, receipt of a command, receipt of predefined information, one or more criteria being satisfied such as criteria associated with a context, etc.), the terminal populates a template for a resource access request. The template for the resource access request can be populated to comprise the resource identifier.

The resource access request can be issued by an application (such as an Internet application). For example, the application can determine or generate the resource access request. The resource access request comprises an identifier, such as a URI corresponding to the target resource for which access is requested. In some embodiments, the resource access request comprises operation type information. The operation type information can indicate a type of operation associated with the resource access request. Operation types include, but are not limited to, one or a combination of operations such as adding, modifying, deleting, and looking up. In some embodiments, the operation type information comprised in the resource access request identifies a type of access for which the resource is being requested.

At 220, at least a type and a relative path for the resource is determined. In some embodiments, the type of resource and the relative path for the resource (e.g., the target resource) are determined based at least in part on the resource access request. For example, the terminal (e.g., an application) can obtain certain information from the resource access request and based at least in part on such information, the terminal determines the type of the resource and/or the relative path for the resource. In some embodiments, the type of the resource and/or the relative path is determined based at least in part on the identifier for the resource comprised in the resource access request. According to various embodiments, the analysis module 110 of the resource access system 100 of FIG. 1 obtains the type of resource and the relative path for the resource based at least in part on the resource access request. The identifier for the resource comprised in the resource access request can comprise resource type indicating information that indicates a type of resource for the resource.

In some embodiments, the resource identifier comprises at least a resource type indicating information and a relative path. Therefore, information obtained through analysis of the resource identifier (e.g., the identifier comprised in the resource access request) at least includes the type of the resource and the relative path of the resource. If the resource identifier comprises other (e.g., additional) information (such as one or more of: the domain name of the domain to which the resource belongs, the username of the user who issued the resource access request, and parameters), the analyzed information can include the content corresponding to such other information comprised in the resource identifier.

In some embodiments, legitimacy verification is performed on the format of the identifier for the target resource (e.g., the resource identifier) before the identifier for the target resource is analyzed. For example, the legitimacy verification is performed in response to obtaining the identifier comprised in the resource access request. Legitimacy verification of the identifier improves the security of the resource access and/or the system. If the verification is successful (e.g., in response to determining that the identifier comprised in the resource access request is legitimate or valid), then the identifier for the target resource can undergo analysis, and the subsequent steps may be executed. If the verification fails (e.g., in response to determining that the identifier comprised in the resource access request is legitimate or valid), the identifier for the target resource is deemed an illegitimate identifier. If the identifier target resource is deemed an illegitimate identifier, then analysis thereof is refused, and thus the response to the resource access request will be refused (e.g., denied). In some embodiments, if a URI is used for the resource identifier, the URI will undergo format verification in accordance with the legitimacy verification described above.

At 230, an absolute path associated with the target resource is determined. In some embodiments, the terminal determines the absolute path corresponding to the resource of the resource access request. As an example, the absolute path for the target resource is determined (e.g., generated) by the generating module 120 of the resource access system 100 of FIG. 1. According to various embodiments, the absolute path for the resource is determined based at least in part on the resource access request. For example, the absolute path for the resource is determined based at least in part on information obtained from the resource access request. The absolute path for the resource can be determined based at least in part on the type of the resource and/or the relative path of the resource.

Examples of implementations for determining the absolute path for the resource if a target resource absolute path is generated based on differences between target resource data types, are provided below:

### Example 1

In response to determining that resource type indicating information corresponding to the resource (e.g., the target resource) indicates that the resource is a first type of resource, the absolute path of the target resource in external memory is generated based at least in part on a resource storage structure in the external memory and on the relative path of the target resource. The resource storage structure can comprise information associated with directory structure, address of the external memory, etc.

In some embodiments, if the identifier for the target resource comprises indicating information for the domain to which the target resource belongs, the resource storage structure in external memory can serve as a basis to determine the directory of the domain to which the target resource belongs, and the absolute path of the target resource in external memory is generated based on the directory and the relative path of the target resource.

For example, if the URI of the target resource carried in the resource access request is:

file://yongsheng/tv.yunos.com/document/test/test.html

The directory for the resource of the tv.yunos.com domain in the terminal SD card is:

pageresource/yongsheng/tv.yunos.com

Thus, the URI of the aforesaid target resource and the resource storage structure in the SD card serve as a basis to generate (e.g., determine) the absolute path of the target resource in the SD card, as shown below:

pageresource/yongsheng/tv.yunos.com/document/test/test.html

### Example 2

In response to determining that resource type indicating information corresponding to the resource indicates that the resource (e.g., the target resource) corresponds to a second type of resource or third type of resource, the local absolute path of the target resource is generated based at least in part on a local resource storage structure and the relative path of the target resource.

In some embodiments, if the indicating information (e.g., the resource type indicating information) for the resource type corresponding to the resource indicates that the resource corresponds to a second type of resource, then the directory of the domain to which the target resource belongs is determined according to the storage structure of a resource of the application (e.g., decompressed application data, etc.), and the local absolute path of the target resource is generated based at least in part on the directory (e.g., of the domain of the external storage) and the relative path of the target resource.

In some embodiments, if the indicating information (e.g., the resource type indicating information) for the resource indicates that the resource corresponds to a third type of resource, then the directory of the domain to which the target resource belongs is determined according to the storage structure of a runtime resource of the application (e.g., local runtime resources of the application), and the local absolute path of the target resource is generated based at least in part on the directory (e.g., of the domain of the local storage) and the relative path of the target resource.

For example, if the URI of the target resource carried in the resource access request is:

page://yongsheng/tv.yunos.com/asset/document/test/test.html

The directory for a decompressed resource of a tv.yunos.com domain application in the terminal SIM card is:

pageresource/unzip/tv.yunos.com

Thus, the URI of the aforesaid target resource and the resource storage structure in the SIM card serve as a basis to generate the absolute path of the target resource in the SIM card, as shown below:

pageresource/unzip/tv.yunos.com/document/test/test.html

As another example, if the URI of the target resource carried in the resource access request is:

page://yongsheng/tv.yunos.com/data/document/test/test.html

The directory for a runtime resource of a tv.yunos.com domain application in the terminal SIM card is:

pageresource/running/tv.yunos.com

Thus, the URI of the aforesaid target resource and the resource storage structure in the SIM card serve as a basis to generate the absolute path of the target resource in the SIM card, as shown below:

pageresource/running/tv.yunos.com/document/test/test.html

### Example 3

In response to determining that the indicating information (e.g., the resource type indicating information) for the resource indicates that the resource corresponds to a fourth type of resource, the resource access request is sent to the network (e.g., the cloud). In response to receiving the resource access request, a server can determine a path for the resource based on a remote storage structure, etc.

According to various embodiments, if resources are located (e.g., stored) in external memory or in a local storage structure and such memory or storage structure comprises a username directory for separately storing resources corresponding to different login users, determining the absolute path is further based on the user name (or other identifier identifying the user).

In some embodiments, the operating system supports multiple languages. In such a situation, resource storage structures can differ under different language settings, or the same application resource can be stored in different directories under different language settings. Accordingly, determining the absolute path for the resource can be further based on the language settings of the terminal (e.g., the operating system). For example, the determining of the absolute path for the resource can be based at least in part on a resource storage structure or directory structure for the applicable language setting of the terminal. Absolute paths can differ for the same target resource under different language settings.

At 240, the target resource is accessed. In some embodiments, the terminal (e.g., the application) can access the target resource. In some embodiments, the terminal provides the user with access to the resource. The terminal can obtain the resource, open the resource, copy the resource, display the resource, etc. The resource can be accessed based at least in part on the absolute path corresponding to the resource. For example, the terminal accesses the resource based at least in part on the determined absolute path associated with the target resource. The access management module 130 of the resource access system 100 of FIG. 1 can access the resource. An example of a target resource being accessed is when a user wants to use a function in an application, the user will open the page of that function in the application, at this time the resource of the page is accessed. An example of when a resource is accessed is if the user desires to play a video in a YouTube® application, then the resource of the video is accessed.

In some embodiments, the terminal comprises the DataManager JavaScript (JS) Application Programming Interface (API). The DataManager JS API can correspond to a resource of the application. The DataManager JS API can correspond to a unified interface for accessing runtime resources (e.g., of the application). For example, the terminal (e.g., an application running thereon) accesses a resource using the DataManager JS API. Through DataManager JS API, the access management module 130 of resource access system 100 of FIG. 1 can access the resources of the application or the runtime resources of the application. The DataManager JS API can be invoked via a Node_DataManager function. As an example, the absolute pat of the resource is provided in or with the call to the DataManager JS API. As another example, the call from the NodeDataManager to the DataManager JS API corresponds to a resource access request. For example, the application can use the Node_DataManager to call DataManager JS API to access resources. In some embodiments, the Node_DataManager is a JS wrapper add-on implementation of a process for providing resource access or one or more resource management capabilities. For example, the Node_DataManager is a JS wrapper add-on implementation of the access management module 130 of resource access system 100. DataManager JS API can be implemented directly on the basis of Node.js JS API and thus avoids implementing the complex, numerous interfaces of Node_DataManager. Design implementation is more concise with effective, repeat use of the Node.js interface.

According to various embodiments, before accessing a resource based on the absolute path of the resource, authority for accessing the corresponding resource is determined. For example, the terminal (e.g., the application) determines whether the application, process, or user associated with the resource access request is authorized to access the resource. Determining whether the application, process, or user associated with the resource access request is authorized can comprise querying a mapping of applications to resources (or types of resources, or domains, etc.), a mapping of processes to resources (or types of resources, or domains, etc.), a mapping of users to resources (or types of resources, or domains, etc.), etc. As an example, the mapping can comprise a whitelist of permitted applications, processes, or users that are authorized to access the corresponding resource. As an example, the mapping can comprise a blacklist of permitted applications, processes, or users that are authorized to access the corresponding resource. If the access of the resource is determined to be authorized, then the resource access is executed. For example, the resource can be accessed in response to determining that access of the resource is authorized. If the access of the resource is not determined to be authorized (or determined to not be authorized), then execution of resource access is denied. The determining of whether access of the resource (e.g., in connection with the resource access request) is authorized can be based at least in part on the domain to which the target resource belongs, information about the user issuing the resource access request (e.g., a user identifier, a credential, etc.), etc.

In some embodiments, user lists, each one corresponding to a different domain or a different resource identifier, are set up in advance. Each of the user lists can include one or more pieces of user information (e.g., username, identifier, etc.). The users in the user list can be deemed to have the authority to access a corresponding resource (e.g., the user list is a user whitelist), or the users in the user list can be deemed to not have the authority to access a corresponding resource (e.g., the user list is a user blacklist). Thus, before a resource is accessed based on the absolute path of the resources, a determination of whether access of the corresponding resource is authored is made based at least in part on information obtained through analysis of the resource access request or the information obtained therefrom (e.g., about the user who issued the resource access request) and the corresponding list indicating authorized accesses (e.g., a user list which was acquired based on the domain to which the target resource belongs, the identifier for the target resource, etc.). If the issuer user (e.g., the user that issued the resource access request) is a user in the list, then the access permission can be granted if the user list corresponds to a list of users that have access authority (e.g., the user list is a user whitelist). If the issuer user (e.g., the user that issued the resource access request) is a user in the list, then the access permission can be denied if the user list corresponds to a list of users that do not have access authority (e.g., the user list is a user blacklist).

In some embodiments, the content of the above user lists are set to “ALL” to indicate that the resource may be accessed by all users or to “NULL” to indicate that the resource cannot be accessed by users.

In some embodiments, resource lists may be set up in advance so that each resource list corresponds to a different user. The resource list can include the URIs of one or more resources and/or the domains to which the resources belong. The resources in the resource list can be accessed by the corresponding user (e.g., if the resource list is a resource whitelist) or not be accessed by the corresponding user (e.g., if the resource list is a resource blacklist). Thus, before accessing a resource based on the absolute path of a resource, a determination of whether access of the resource is authorized is made based on the URI (or other identifier associated with the resource) or the domain to which the target resource belongs (e.g., the latter being obtained through analysis) combined with the corresponding resource list which was obtained based on information about the user who issued the resource access request (e.g., an identifier comprised in the resource access request or communicated in connection with the resource access request). If the target resource corresponds to a resource comprised in the list (e.g., if the resource list is a resource whitelist), then the access permission can be granted. If the target resource corresponds to a resource comprised in the list (e.g., if the resource list is a resource blacklist), the access permission can be refused.

In some embodiments, the contents of the above resource lists are set to “ALL” to indicate that the user has access authority for all resources or to “NULL” to indicate that the user does not have access authority for any of the resources.

According to various embodiments, the resource access security may be further improved by combining the two decision-making approaches described above.

In some embodiments, a resource access key (or other credential) is allocated (e.g., assigned) in advance. The stored access key is first encrypted and then stored. As an example, in connection with the target resource being accessed, the corresponding resource access key is used to perform a decryption operation on the resource (e.g., the target resource). In some embodiments, resource access is permitted in response to successful decryption. For example, resource access is only provided after a successful decryption. Thus, a legitimate user can use the pre-allocated resource access key to decrypt the target resource and obtain the decrypted target resource. An illegitimate user cannot obtain the resource access key and therefore cannot access the resource. Resource access security is thereby improved.

In some embodiments, if an attempt to access the resource based on the absolute address of the target resource fails, a resource synchronizing process can be invoked (e.g., executed) to synchronize resources on another terminal or the cloud with local resources (e.g., a server storing resources). For example, if an attempt to access a resource in connection with a resource access request fails (e.g., at 240 of process 200 of FIG. 2), the resource synchronization process is performed. As an example, if the resource whose access has been requested cannot be accessed (such situations generally occur because the requested resource is not present locally but is on another terminal or in the cloud), a resource synchronizing process may be executed to synchronize resources on another terminal or the cloud with local resources.

In some embodiments, the access management module 130 of resource access system 100 of FIG. 1 sends a resource synchronization request to the network service module 140. The access management module 130 can also receive a resource (including the requested target resource) sent back by the network based on the resource synchronization request, and thus maintain synchronization with network resources.

According to various embodiments, a target resource identifier in a resource access request contains a relative path (e.g., a non-absolute path). The relative path of the target resource and the type of target resource can be determined based at least in part on the target resource identifier. Information obtained through analysis of the resource identifier serves as a basis to generate an absolute path for the target resource, and the target resource can be accessed according to the absolute path. The problems of the related art resulting from the need for an access request to carry a target resource absolute path can be overcome because the target resource identifier does not need to carry an absolute path.

In addition, because the target resource path comprised in the identifier for the target data in a resource access request is a relative path (e.g., the path of the target resource in the domain to which the resource belongs), if the directory of the domain to which the target resource belongs is changed, the resource can be accessed without having to change the relative path of the target resource.

More specifically, the following objectives can be achieved through various embodiments of the present application:

helping to achieve a standardized definition for uniform access by defining a new URI to identify a resource;

defining a resource type to identify the local (or “non-external memory”) resource and thus helping to differentiate between different types of resources and facilitate local, external memory, and cloud resource access;

Accessing resources via relative paths without requiring the user to input an absolute path of the resource to be accessed, thus enabling cross-domain access of resources through relative paths.

Local or cloud resource access can use a unified interface, which helps application developers to develop applications.

By adopting various embodiments of the present application, one or more of the following functions can be implemented:

resource access: providing a uniform resource access approach with a defined resource identifier (e.g., the resource identifier is defined according to one or more defined parameters), thus enabling easy access to local or cloud resources;

resource caching: caching resources with a defined resource identifier defined (e.g., the resource identifier is defined according to one or more defined parameters);

resource synchronization: synchronizing local and cloud resources or resources across terminals with a defined resource identifier (e.g., the resource identifier is defined according to one or more defined parameters);

resource isolation: achieving secure access and cross-domain access to resources;

sharing resources: achieving cloud sharing of resources (e.g., all or a set of resources on all or a set of the terminals belonging to one user remaining synchronized with the cloud), achieving terminal-to-terminal sharing (e.g., resources on different terminals of one user may be accessed or synchronized), and achieving cross-domain sharing.

FIG. 3 is a structural diagram of a terminal according to various embodiments of the present application.

Referring to FIG. 3, terminal 300 is provided. Terminal 300 can implement process 200 of FIG. 2. Terminal 300 can use resource access system 100 of FIG. 1. Terminal 300 can be implemented at least in part by computer system 400 of FIG. 4.

Terminal 300 can comprise processor 310, memory 320, and display device 330.

Processor 310 can be a general processor (e.g., a microprocessor or any conventional processor), a digital signal processor, an application-specific integrated circuit, a field-programmable gate array or other programmable logic device, a discrete gate or transistor logic, or a discrete hardware component. Memory 320 can comprise internal memory and/or external memory (e.g., random access memory, flash memory, read-only memory, programmable read-only memory, electrically erasable programmable memory, a register, or another mature storage medium in the art). Display device 330 can comprise a touchscreen control circuit.

Processor 310 can have data communication links with other modules in the terminal 300. For example, processor 310 can engage in data communication based on a bus architecture. The bus architecture can include any quantity of interconnected buses and bridges linking together one or more processors represented by the processor 310 and various memory circuits represented by memory 320. The bus architecture can further link together various other circuits such as those of peripheral devices, voltage stabilizers, and power management circuits. All of these are known in the art and thus will not be described further herein. Interfaces are provided by bus interfaces. The processor 310 is responsible for managing bus architecture and general processing. Memory 320 can store the data used by the processor 310 when executing operations.

Processor 310 can implement the resource management process according to various embodiments. During implementation, one or more steps (e.g., each step) in the resource access process flow can be completed by an integrated logic circuit of the hardware in the processor 310 or by a software instruction. Each method, step, and logic block disclosed by various embodiments can be thus implemented or executed. Steps of methods disclosed by various embodiments can be directly embodied as hardware and completed by the processor. Steps of methods disclosed by various embodiments can be completed by a combination of hardware and software modules in the processor. A software module may be located in random access memory, flash memory, read-only memory, programmable read-only memory, electrically erasable programmable memory, a register, or another mature storage medium in the art.

According to various embodiments, processor 310, coupled to the memory 320, is configured to read the computer program instructions stored by the memory 320 and, in response, execute the operations below:

Receiving a resource access request, the resource access request comprising an identifier for a resource. The resource corresponding to the identifier comprised in the resource access request can correspond to a target resource for which access is requested.

Obtaining at least a resource type of the resource and a relative path of the resource. The at least a resource type of the resource and a relative path of the resource can be determined based at least in part on the identifier for the resource (e.g., the identifier of the target resource, the identifier being comprised in the resource access request).

Generating the absolute path of the resource. The absolute path for the target resource can be determined based on information obtained through analysis. For example, the absolute path for the target resource is determined by a resource type of the resource and a relative path of the resource.

Accessing the target resource based on the absolute path for the resource.

The resource identifier can be a resource URI.

The resource identifier (e.g., the URI) can comprise the following information fields:

a resource type field, for carrying (e.g., comprising) resource type indicating information;

a domain name field, for carrying (e.g., comprising) indicating information for the domain to which a resource belongs;

a path field, for carrying (e.g., comprising) the path of the resource in the domain to which the resource belongs.

The resource type fields comprise a first field and a second field. If the value of the first field indicates that the target resource type corresponds to the first type, then the second field can be null; otherwise, the value of the second field indicates that the target resource type is a second type or third type.

The resource identifier (e.g., the URI) can also comprise one or a combination of the following information fields:

A user information field, for carrying (e.g., comprising) information associated with (e.g., identifying) the user who issued the resource access request.

A parameter field, for carrying (e.g., comprising) a parameter.

The identifier for the target resource can comprise indicating information that indicates a resource type of the resource. The resource type can comprise:

A first type, for indicating that the resource is stored in external memory.

A second type, for indicating that the resource is not stored in external memory and that the resource corresponds to a resource of the application (e.g., decompressed data, not a runtime resource of the application).

A third type, for indicating that the resource is not stored in external memory and that the resource corresponds to a runtime resource of the application.

The identifier for the target resource can comprise: a resource type indicating information fields, the resource type indicating information fields comprising a first field and a second field;

As an example, if the value of the first field indicates that the target resource type corresponds to a first type of resource, then the second field is null; otherwise, the value of the second field indicates that the target resource corresponds to a second type of resource or a third type of resource.

In some embodiments, in connection with determining the absolute path for the target resource, the processor 310 is configured to generate the absolute path of the target resource in external memory based on the resource storage structure in the external memory and the relative path of the target resource, if the indicating information for the target resource indicates that the target resource corresponds to a first type of resource. The processor 310 can be configured to generate the local absolute path of the target resource based on the local resource storage structure and the relative path of the target resource if the indicating information of the target resource type indicates that the resource corresponds to a second type of resource or a third type of resource.

The identifier for the target resource can further comprise indicating information for the domain to which the target resource belongs. In some embodiments, processor 310 is configured to use the resource storage structure in external memory as a basis to determine the directory of the domain to which the target resource belongs and/or to determine the absolute path of the target resource in the external memory based on the directory and the relative path of the target resource.

In some embodiments, the identifier for the target resource further comprises indicating information for the domain to which the target resource belongs. Accordingly, if the indicating information for the resource indicates that the target resource corresponds to a second type of resource, then the processor 310 can determine the directory of the domain to which the target resource belongs based on the storage structure of a resource of an application (e.g., a storage structure of a resource of a local application such as decompressed data and/or data that is not runtime data for the application). Processor 310 can generate the local absolute path of the target resource based on the directory and the relative path of the target resource. If the indicating information for the target resource indicates that the target resource corresponds to a third type of resource, then processor 310 can determine the directory of the domain to which the target resource belongs based on the storage structure of a runtime resource of an application (e.g., a local application). Processor 310 can generate the local absolute path of the target resource based on the directory and the relative path of the target resource.

Processor 310 can perform a legitimacy verification process on the identifier for the target resource. For example, the processor 310 can perform the legitimacy verification process on the identifier for the target resource in response to obtaining the resource access request. Processor 310 can subject the format of the identifier for the target resource to legitimacy verification before analyzing the identifier for the target resource.

The identifier for the target resource can comprise indicating information of the domain to which the target resource belongs, and the relative path obtained through analysis is a path in the domain to which the target resource belongs; and/or the identifier for the target resource can comprise information about the issuing user of the resource access request.

In some embodiments, before accessing the target resource based on the absolute path of the target resource, the processor 310 makes an access authority decision regarding the resource access request based on information about the user who issued the resource access request, one piece or a combination of pieces of indicating information for the domain to which the target resource belongs, and a preset access authority decision rule.

The processor 310 can acquire a preset resource list based on and corresponding to information about the user who issued the resource access request and make an access authority decision regarding the resource access request based on the information about the issuing user and on the acquired resource list, wherein the resources in the resource list permit or do not permit access by the issuing user; or the processor 310 acquires a preset user list based on and corresponding to a target resource identifier carried in the resource access request or to the domain to which the target resource belongs, and makes an access authority decision regarding the resource access request based on the target resource identifier or the domain to which the target resource belongs, wherein the users in the user list are permitted or not permitted access to the target resource.

In some embodiments, in connection with the accessing of the target resource based on the absolute path for the target resource, the processor 310 uses a pre-allocated resource access key to decrypt the target resource and obtains the decrypted target resource.

Processor 310 can launch a resource synchronization process if access of the resource fails while accessing the target resource based on the absolute path of the target resource.

The present application is described with reference to flowcharts and/or block diagrams based on methods, devices (systems), and computer program products of embodiments of the present application. Please note that each process flow and/or block within the flowcharts and/or block diagrams and combinations of process flows and/or blocks within the flowcharts and/or block diagrams can be implemented by computer instructions. These computer program instructions can be provided to general-purpose computers, special-purpose computers, embedded processors, or processors of other data-processing devices to give rise to a machine such that the instructions by the computers or by the processors of other programmable data-processing devices give rise to devices used to implement the functions specified in one or more processes in a flowchart and/or in one or more blocks in a block diagram.

These computer program instructions can also be stored in computer-readable memory that can guide computers or other programmable data-processing devices to operate according to specific modes, with the result that the instructions stored in this computer-readable memory give rise to products that include command means. These command means implement the functions specified in one or more processes in a flow chart and/or one or more blocks in a block diagram.

These computer program instructions can also be loaded onto a computer or other programmable data-processing device, with the result that a series of operating steps are executed on a computer or other programmable device so as to give rise to computer processing. In this way, the instructions executed on a computer or other programmable device provide steps for implementing the functions specified by one or more processes in a flow chart and/or one or more blocks in a block diagram.

FIG. 4 is a functional diagram of a computer system for resource access according to various embodiments of the present application.

Referring to FIG. 4, computer system 400 is provided. Computer system 400 can implement at least part of process 200 of FIG. 2. Computer system 400 can implement at least part of system 100 of FIG. 1 and/or terminal 300 of FIG. 3.

Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418).

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data, and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown). The memory can be a non-transitory computer-readable storage medium.

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storage device 412 and fixed mass storage 420 generally store additional programming instructions, data, and the like that typically are not in active use by the processor 402. It will be appreciated that the information retained within mass storage device 412 and fixed mass storage 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

Although preferred embodiments of the present application have already been described, persons skilled in the art can make other alterations and modifications to these embodiments once they grasp the basic creative concept. Therefore, the attached claims are to be interpreted as including the preferred embodiments as well as all alterations and modifications falling within the scope of the present application.

Obviously, a person skilled in the art can modify and vary the present application without departing from the spirit and scope of the present application. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining, by one or more processors, a resource access request, the resource access request comprising an identifier for a resource for which access is requested;
obtaining, by the one or more processors, at least a resource type of the resource and a relative path corresponding to the resource, the resource type and the relative path being obtained based at least in part on the identifier included in the resource access request;
determining, by the one or more processors, an absolute path corresponding to the resource, the absolute path being determined based at least in part on one or more of the resource type and the relative path; and
accessing, by the one or more processors, the resource based at least in part on the absolute path corresponding to the resource.

2. The method of claim 1, wherein the identifier for the resource comprises resource type indicating information that indicates the resource type, wherein the resource type corresponds to:
a first type of resource, wherein the first type of resource is stored in an external memory;
a second type of resource, wherein the second type of resource is not stored in external memory and is an application resource; or
a third type of resource, wherein the third type of resource is not stored in external memory and is a runtime resource of an application.

3. The method of claim 2, wherein the application resource comprises decompressed data that is not runtime resources of the application.

4. The method of claim 2, wherein:
the identifier for the resource comprises: resource type fields, the resource type fields comprising a first field and a second field, the first field being used to indicate that the resource corresponds to the first type of resource, and the second field being used to indicate that the resource corresponds to the second type of resource or the third type of resource.

5. The method of claim 2, wherein:
in response to determining that the resource type indicating information indicates that the resource corresponds to the first type of resource, the absolute path is determined to correspond to the resource stored in external memory based on a resource storage structure in the external memory and the relative path; and
in response to determining that the resource type indicating information indicates that the resource corresponds to the second type of resource or the third type of resource, the absolute path is determined to correspond to the resource based on a local resource storage structure and the relative path.

6. The method of claim 5, wherein:
the identifier comprises indicating information that indicates a domain to which the resource belongs; and
the determining the absolute path corresponding to the resource stored in the external memory based on the resource storage structure in the external memory and the relative path comprises:
determining a directory of the domain to which the resource belongs, wherein the directory of the domain is determined based at least in part on the resource storage structure in the external memory; and
determining the absolute path corresponding to the resource based at least in part on the directory of the domain to which the resource belongs, and the relative path.

7. The method of claim 5, wherein:
the identifier comprises indicating information that indicates a domain to which the resource belongs; and
the determining the absolute path corresponding to the resource based at least in part on the local resource storage structure and the relative path comprises:
in response to determining that the indicating information indicates that the resource corresponds to the second type of resource, determining a directory of the domain to which the resource belongs based at least in part on a storage structure of an application resource, and determining the absolute path corresponding to the resource based at least in part on the directory of the domain to which the resource belongs, and the relative path; and
in response to determining that the indicating information indicates that the resource corresponds to the third type of resource, determining the directory of the domain to which the resource belongs based at least in part on the storage structure of a runtime resource of the application, and determining the absolute path corresponding to the resource based at least in part on the directory of the domain to which the resource belongs and the relative path.

8. The method of claim 1, further comprising:
performing a legitimacy verification on a format of the identifier.

9. The method of claim 1, wherein the identifier comprises:
indicating information that indicates a domain to which the resource belongs, the relative path corresponding to a path in the domain to which the resource belongs, or
information associated with a user that issued the resource access request, or
information that indicates a domain to which the resource belongs and information associated with a user that issued the resource access request.

10. The method of claim 9, further comprising:
determining whether resource access is permitted based at least in part on information associated with the user that issued the resource access request, the indicating information that indicates the domain to which the resource belongs, and one or more rules for authorized access.

11. The method of claim 10, wherein:
the determining whether the resource access is permitted comprises:
obtaining a preset resource list based at least in part on the information associated with the user that issued the resource access request, determining whether the resource access is permitted based at least in part on the information associated with the user and the preset resource list, wherein the determining whether the resource access is permitted is based at least in part on whether resources are identified in the preset resource list; or
obtaining a preset user list based at least in part on the identifier for the resource comprised in the resource access request or the domain to which the resource belongs, and determining whether the resource access is permitted based at least in part on the identifier for the resource or the domain to which the resource belongs, and at least in part on the preset user list, wherein the determining whether the resource access is permitted is based at least in part on whether the user associated with the resource access request is identified in the preset user list.

12. The method of claim 1, wherein the accessing the resource based at least in part on the absolute path corresponding to the resource comprises:
decrypting the resource based at least in part on a pre-allocated resource access key; and
obtaining a decrypted resource.

13. The method of claim 1, further comprising:
in response to determining that accessing the resource based at least in part on the absolute path corresponding to the resource fails, launching a resource synchronization process.

14. The method of claim 1, wherein the resource identifier is a Uniform Resource Identifier (URI).

15. The method of claim 14, wherein the URI comprises one or more information fields corresponding to:
one or more resource type fields, the one or more resource type fields comprising resource type indicating information;
a domain name field, the domain name field comprising indicating information that indicates a domain to which the resource belongs; and
a path field, the path field comprising a path of the resource in the domain to which the resource belongs.

16. The method of claim 15, wherein:
the resource type fields comprise a first field and a second field, the first field being used to indicate that the resource corresponds to a first type of resource, and the second field being used to indicate that the resource corresponds to a second type of resource or a third type of resource.

17. The method of claim 15, wherein the URI further comprises one or more information fields corresponding to:
a user information field, the user information field comprising information associated with a user that issued the resource access request; and/or
a parameter field, the parameter field comprising a parameter.

18. The method of claim 1, further comprising: in response to accessing the resource, providing the resource to a user.

19. The method of claim 1, further comprising: in response to accessing the resource, providing the resource to an application, and performing one or more commands based on the resource.

20. The method of claim 1, wherein accessing the resource comprises copying the resource, modifying the resource, or deleting the resource.

21. A device, comprising:
one or more processors configured to:
obtain a resource access request, the resource access request comprising an identifier for a resource for which access is requested;
obtain at least a resource type of the resource and a relative path corresponding to the resource, the resource type and the relative path being obtained based at least in part on the identifier comprised in the resource access request;
determine an absolute path corresponding to the resource, the absolute path being determined based at least in part on one or more of the resource type and the relative path; and
access the resource based at least in part on the absolute path corresponding to the resource; and
one or more memories coupled to the one or more processors, configured to provide the one or more processors with instructions.

22. A computer program product, the computer program product being embodied in a non-transitory computer readable storage medium and comprising computer instructions for:
obtaining, by one or more processors, a resource access request, the resource access request comprising an identifier for a resource for which access is requested;
obtaining, by the one or more processors, at least a resource type of the resource and a relative path corresponding to the resource, the resource type and the relative path being obtained based at least in part on the identifier comprised in the resource access request;
determining, by the one or more processors, an absolute path corresponding to the resource, the absolute path being determined based at least in part on one or more of the resource type and the relative path; and
accessing, by the one or more processors, the resource based at least in part on the absolute path corresponding to the resource.
